(19) United States
(12) Patent Application Publication
(10) Pub. No.: US 2020/0172106 A1
(43) Pub. Date: Jun. 4, 2020

(54) SYSTEM AND METHOD FOR CONTROL OF AN AUTONOMOUS VEHICLE

(71) Applicant: GM GLOBAL TECHNOLOGY OPERATIONS LLC, Detroit, MI (US)

(72) Inventors: Kevin A. O'Dea, Ann Arbor (US); Sami Ahmed, Orion Township, MI (US); Shiv G. Patel, Toronto (CA)

(21) Appl. No.: 16/208,824

(22) Filed: Dec. 4, 2018

(51) Int. Cl. B60W 30/18; B60W 30/12; G06K 9/00; G05D 1/00

(52) U.S. Cl. CPC B60W 30/18163; B60W 30/12; G06K 9/00825; G05D 2201/0213; B60W 2550/302; B60W 2550/306; G05D 1/0088

(57) ABSTRACT

An automotive vehicle includes an actuator, a sensor, and a controller configured to selectively control the actuator in an autonomous driving mode. The controller is configured to identify an adjacent driving lane proximate a current driving lane based on signals from the sensor. The controller is configured to access a current lane preference value and an adjacent lane preference value from non-transient data memory. The controller is configured to calculate a relative position and relative velocity of a target object external to the vehicle. The controller is configured to calculate a current lane weight value for the current driving lane and an adjacent lane weight value for the adjacent driving lane. The controller is configured to, in response to the adjacent lane weight value exceeding the current lane weight value, automatically control the actuator to perform a lane change maneuver from the current driving lane to the adjacent driving lane.

### INTRODUCTION

The present disclosure relates to vehicles controlled by automated driving systems, particularly those configured to automatically control vehicle steering, acceleration, and braking during a drive cycle without human intervention.

The operation of modern vehicles is becoming more automated, i.e. able to provide driving control with less and less driver intervention. Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

### SUMMARY

An automotive vehicle according to the present disclosure includes at least one actuator configured to control vehicle steering, shifting, acceleration, or braking, at least one sensor configured to provide signals indicative of features external to the vehicle, and a controller in communication with non-transient data memory. The controller is configured to selectively control the at least one actuator in an autonomous driving mode. The controller is additionally configured to identify an adjacent driving lane proximate a current driving lane of the automotive vehicle based on signals from the at least one sensor. The controller is also configured to access a current lane preference value associated with the current driving lane and an adjacent lane preference value associated with the adjacent driving lane. The current lane preference value and the adjacent lane preference value are calibrated values stored in the non-transient data memory. The controller is further configured to calculate a relative position and relative velocity of a target object external to the vehicle. The controller is further configured to calculate, based on the current lane preference value, the adjacent lane preference value, the relative position of the target object, and the relative velocity of the target object, a current lane weight value for the current driving lane and an adjacent lane weight value for the adjacent driving lane. The controller is further configured to, in response to the adjacent lane weight value exceeding the current lane weight value and the controller controlling the at least one actuator in the autonomous driving mode, automatically control the at least one actuator to perform a lane change maneuver from the current driving lane to the adjacent driving lane.

In an exemplary embodiment, the adjacent driving lane is positioned to the passenger side of the current driving lane, and the adjacent lane preference value exceeds the current lane preference value.

In an exemplary embodiment, the adjacent driving lane is positioned to the passenger side of the current driving lane, and, in response to the target object comprising an emergency vehicle, the adjacent lane weight exceeds the current lane weight.

In an exemplary embodiment, the controller is further configured to identify a second adjacent driving lane proximate the current driving lane based on signals from the at least one sensor, and to access a second adjacent lane preference value associated with the second adjacent driving lane. The second adjacent lane preference value is a calibrated value stored in the non-transient data memory. The controller is additionally configured to calculate, based on the second adjacent lane preference value, a second adjacent lane weight value for the second adjacent driving lane, and to, in response to the second adjacent lane weight value exceeding the current lane weight value and the controller controlling the at least one actuator in the autonomous driving mode, automatically control the at least one actuator to perform a lane change maneuver from the current driving lane to the second adjacent driving lane.

In an exemplary embodiment the target object is positioned in the adjacent driving lane, and the controller is further configured to calculate an adjacent lane traffic density parameter based on the relative position and relative velocity of the target object. In such embodiments, the adjacent lane weight value is based on the adjacent lane traffic density parameter. The controller may be further configured to calculate a second relative position and a second relative velocity of a second target object external to the vehicle, with the second object being positioned in the adjacent driving lane, and the traffic density parameter being further based on the second relative position and the second relative velocity.

In an exemplary embodiment, the target object is positioned in the current driving lane, and the current lane weight value is based on the relative position and relative velocity of the target object. The target object may be positioned ahead of the vehicle.

A method of controlling a vehicle according to the present disclosure includes providing the vehicle with at least one actuator configured to control vehicle steering, shifting, acceleration, or braking, at least one sensor configured to provide signals indicative of features external to the vehicle, and a controller in communication with non-transient data memory. The controller is configured to selectively control the at least one actuator in an autonomous driving mode. The method also includes identifying, via the controller, an adjacent driving lane proximate a current driving lane of the automotive vehicle based on signals from the at least one sensor. The method additionally includes accessing, via the controller, a current lane preference value associated with the current driving lane and an adjacent lane preference value associated with the adjacent driving lane. The current lane preference value and the adjacent lane preference value are calibrated values stored in the non-transient data memory. The method further includes calculating, via the controller, a relative position and relative velocity of a target object external to the vehicle. The method still further includes calculating, via the controller, a current lane weight value for the current driving lane and an adjacent lane weight value for the adjacent driving lane based on the current lane preference value, the adjacent lane preference value, the relative position of the target object, and the relative velocity of the target object. The method still further includes, in response to the adjacent lane weight value exceeding the current lane weight value and the controller controlling the at least one actuator in the autonomous driving mode, automatically controlling the at least one actuator to perform a lane change maneuver from the current driving lane to the adjacent driving lane.

In an exemplary embodiment, the method additionally includes providing the vehicle with a body having a driver side and a passenger side. The adjacent driving lane is positioned to the passenger side of the current driving lane, and the adjacent lane preference value exceeds the current lane preference value.

In an exemplary embodiment, the method additionally includes providing the vehicle with a body having a driver side and a passenger side. The adjacent driving lane is positioned to the passenger side of the current driving lane, and, in response to the target object comprising an emergency vehicle, the adjacent lane weight exceeds the current lane weight.

In an exemplary embodiment, the method additionally includes identifying, via the controller, a second adjacent driving lane proximate the current driving lane based on signals from the at least one sensor. The method also includes accessing, via the controller, a second adjacent lane preference value associated with the second adjacent driving lane. The second adjacent lane preference value is a calibrated value stored in the non-transient data memory. The method further includes calculating, based on the second adjacent lane preference value, a second adjacent lane weight value for the second adjacent driving lane. The method still further includes, in response to the second adjacent lane weight value exceeding the current lane weight value and the controller controlling the at least one actuator in the autonomous driving mode, automatically controlling the at least one actuator to perform a lane change maneuver from the current driving lane to the second adjacent driving lane.

In an exemplary embodiment, the target object is positioned in the adjacent driving lane. In such an embodiment, the method additionally includes calculating, via the controller, an adjacent lane traffic density parameter based on the relative position and relative velocity of the target object. The adjacent lane weight value is based on the adjacent lane traffic density parameter. In such embodiments, the method may additionally include calculating, via the controller, a second relative position and a second relative velocity of a second target object external to the vehicle. The second object is positioned in the adjacent driving lane, and the traffic density parameter is further based on the second relative position and the second relative velocity.

In an exemplary embodiment, the target object is positioned in the current driving lane, and the current lane weight value is based on the relative position and relative velocity of the target object. The target object may be positioned ahead of the vehicle.

Embodiments according to the present disclosure provide a number of advantages. For example, the present disclosure provides a system and method for controlling an automotive vehicle to autonomously determine whether a lane change is desirable, and to perform such a lane change if so.

The above and other advantages and features of the present disclosure will be apparent from the following detailed description of the preferred embodiments when taken in connection with the accompanying drawings.

### BRIEF DESCRIPTION OF THE DRAWINGS

FIG. 1 is a schematic diagram of a communication system including an autonomously controlled vehicle according to an embodiment of the present disclosure;

FIG. 2 is a schematic block diagram of an automated driving system (ADS) for a vehicle according to an embodiment of the present disclosure;

FIG. 3 is a flowchart representation of a method of controlling a vehicle according to a first embodiment of the present disclosure; and

FIG. 4 is an illustrative representation of a vehicle according to an embodiment of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but are merely representative. The various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

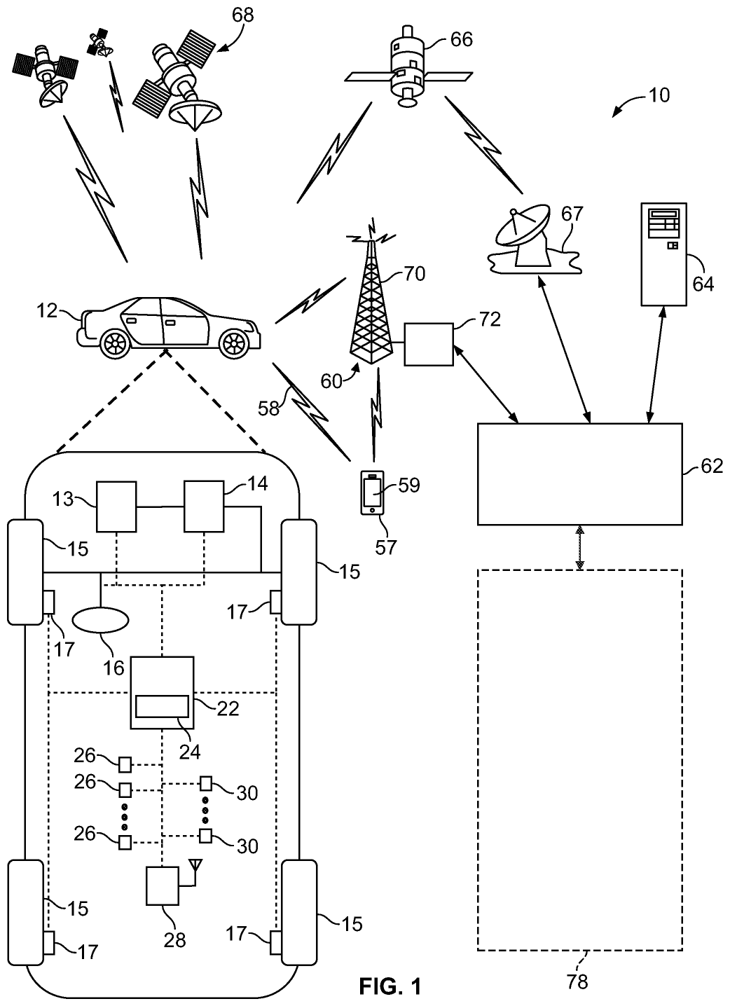

FIG. 1 schematically illustrates an operating environment that comprises a mobile vehicle communication and control system 10 for a motor vehicle 12. The motor vehicle 12 may be referred to as a host vehicle. The communication and control system 10 for the host vehicle 12 generally includes one or more wireless carrier systems 60, a land communications network 62, a computer 64, a mobile device 57 such as a smart phone, and a remote access center 78.

The host vehicle 12, shown schematically in FIG. 1, is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. The host vehicle 12 includes a propulsion system 13, which may in various embodiments include an internal combustion engine, an electric machine such as a traction motor, and/or a fuel cell propulsion system.

The host vehicle 12 also includes a transmission 14 configured to transmit power from the propulsion system 13 to a plurality of vehicle wheels 15 according to selectable speed ratios. According to various embodiments, the transmission 14 may include a step-ratio automatic transmission, a continuously-variable transmission, or other appropriate transmission. The host vehicle 12 additionally includes wheel brakes 17 configured to provide braking torque to the vehicle wheels 15. The wheel brakes 17 may, in various embodiments, include friction brakes, a regenerative braking system such as an electric machine, and/or other appropriate braking systems.

The host vehicle 12 additionally includes a steering system 16. While depicted as including a steering wheel for illustrative purposes, in some embodiments contemplated within the scope of the present disclosure, the steering system 16 may not include a steering wheel.

The host vehicle 12 includes a wireless communications system 28 configured to wirelessly communicate with other vehicles (“V2V”) and/or infrastructure (“V2I”). In an exemplary embodiment, the wireless communication system 28 is configured to communicate via a dedicated short-range communications (DSRC) channel. DSRC channels refer to one-way or two-way short-range to medium-range wireless communication channels specifically designed for automotive use and a corresponding set of protocols and standards. However, wireless communications systems configured to communicate via additional or alternate wireless communications standards, such as IEEE 802.11 and cellular data communication, are also considered within the scope of the present disclosure.

The propulsion system 13, transmission 14, steering system 16, and wheel brakes 17 are in communication with or under the control of at least one controller 22. While depicted as a single unit for illustrative purposes, the controller 22 may additionally include one or more other controllers, collectively referred to as a “controller.” The controller 22 may include a microprocessor or central processing unit (CPU) in communication with various types of computer readable storage devices or media. Computer readable storage devices or media may include volatile and nonvolatile storage in read-only memory (ROM), random-access memory (RAM), and keep-alive memory (KAM), for example. KAM is a persistent or non-volatile memory that may be used to store various operating variables while the CPU is powered down. Computer-readable storage devices or media may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 22 in controlling the vehicle.

The controller 22 includes an automated driving system (ADS) 24 for automatically controlling various actuators in the vehicle. In an exemplary embodiment, the ADS 24 is a so-called Level Three automation system. A Level Three system indicates “Conditional Automation”, referring to the driving mode-specific performance by an automated driving system of all aspects of the dynamic driving task with the expectation that the human operator will respond appropriately to a request to intervene.

Other embodiments according to the present disclosure may be implemented in conjunction with so-called Level One or Level Two automation systems. A Level One system indicates “driver assistance”, referring to the driving mode-specific execution by a driver assistance system of either steering or acceleration using information about the driving environment and with the expectation that the human operator perform all remaining aspects of the dynamic driving task. A Level Two system indicates “Partial Automation”, referring to the driving mode-specific execution by one or more driver assistance systems of both steering and acceleration using information about the driving environment and with the expectation that the human operator perform all remaining aspects of the dynamic driving task.

Still other embodiments according to the present disclosure may also be implemented in conjunction with so-called Level Four or Level Five automation systems. A Level Four system indicates “high automation”, referring to the driving mode-specific performance by an automated driving system of all aspects of the dynamic driving task, even if a human operator does not respond appropriately to a request to intervene. A Level Five system indicates “full automation”, referring to the full-time performance by an automated driving system of all aspects of the dynamic driving task under all roadway and environmental conditions that can be managed by a human operator.

In an exemplary embodiment, the ADS 24 is configured to control the propulsion system 13, transmission 14, steering system 16, and wheel brakes 17 to control vehicle acceleration, steering, and braking, respectively, without human intervention via a plurality of actuators 30 in response to inputs from a plurality of sensors 26, which may include GPS, RADAR, LIDAR, optical cameras, thermal cameras, ultrasonic sensors, and/or additional sensors as appropriate.

FIG. 1 illustrates several networked devices that can communicate with the wireless communication system 28 of the host vehicle 12. One of the networked devices that can communicate with the host vehicle 12 via the wireless communication system 28 is the mobile device 57. The mobile device 57 can include computer processing capability, a transceiver capable of communicating signals 58 using a short-range wireless protocol, and a visual smart phone display 59. The computer processing capability includes a microprocessor in the form of a programmable device that includes one or more instructions stored in an internal memory structure and applied to receive binary input to create binary output. In some embodiments, the mobile device 57 includes a GPS module capable of receiving signals from GPS satellites 68 and generating GPS coordinates based on those signals. In other embodiments, the mobile device 57 includes cellular communications functionality such that the mobile device 57 carries out voice and/or data communications over the wireless carrier system 60 using one or more cellular communications protocols, as are discussed herein. The visual smart phone display 59 may also include a touch-screen graphical user interface.

The wireless carrier system 60 is preferably a cellular telephone system that includes a plurality of cell towers 70 (only one shown), one or more mobile switching centers (MSCs) 72, as well as any other networking components required to connect the wireless carrier system 60 with the land communications network 62. Each cell tower 70 includes sending and receiving antennas and a base station, with the base stations from different cell towers being connected to the MSC 72 either directly or via intermediary equipment such as a base station controller. The wireless carrier system 60 can implement any suitable communications technology, including for example, analog technologies such as AMPS, or digital technologies such as CDMA (e.g., CDMA2000) or GSM/GPRS. Other cell tower/base station/MSC arrangements are possible and could be used with the wireless carrier system 60. For example, the base station and cell tower could be co-located at the same site or they could be remotely located from one another, each base station could be responsible for a single cell tower or a single base station could service various cell towers, or various base stations could be coupled to a single MSC, to name but a few of the possible arrangements.

Apart from using the wireless carrier system 60, a second wireless carrier system in the form of satellite communication can be used to provide uni-directional or bi-directional communication with the host vehicle 12. This can be done using one or more communication satellites 66 and an uplink transmitting station 67. Uni-directional communication can include, for example, satellite radio services, wherein programming content (news, music, etc.) is received by the transmitting station 67, packaged for upload, and then sent to the satellite 66, which broadcasts the programming to subscribers. Bi-directional communication can include, for example, satellite telephony services using the satellite 66 to relay telephone communications between the host vehicle 12 and the station 67. The satellite telephony can be utilized either in addition to or in lieu of the wireless carrier system 60.

The land network 62 may be a conventional land-based telecommunications network connected to one or more landline telephones and connects the wireless carrier system 60 to the remote access center 78. For example, the land network 62 may include a public switched telephone network (PSTN) such as that used to provide hardwired telephony, packet-switched data communications, and the Internet infrastructure. One or more segments of the land network 62 could be implemented through the use of a standard wired network, a fiber or other optical network, a cable network, power lines, other wireless networks such as wireless local area networks (WLANs), or networks providing broadband wireless access (BWA), or any combination thereof. Furthermore, the remote access center 78 need not be connected via land network 62, but could include wireless telephony equipment so that it can communicate directly with a wireless network, such as the wireless carrier system 60.

While shown in FIG. 1 as a single device, the computer 64 may include a number of computers accessible via a private or public network such as the Internet. Each computer 64 can be used for one or more purposes. In an exemplary embodiment, the computer 64 may be configured as a web server accessible by the host vehicle 12 via the wireless communication system 28 and the wireless carrier 60. Other computers 64 can include, for example: a service center computer where diagnostic information and other vehicle data can be uploaded from the vehicle via the wireless communication system 28 or a third party repository to or from which vehicle data or other information is provided, whether by communicating with the host vehicle 12, the remote access center 78, the mobile device 57, or some combination of these. The computer 64 can maintain a searchable database and database management system that permits entry, removal, and modification of data as well as the receipt of requests to locate data within the database. The computer 64 can also be used for providing Internet connectivity such as DNS services or as a network address server that uses DHCP or other suitable protocol to assign an IP address to the host vehicle 12. The computer 64 may be in communication with at least one supplemental vehicle in addition to the host vehicle 12. The host vehicle 12 and any supplemental vehicles may be collectively referred to as a fleet.

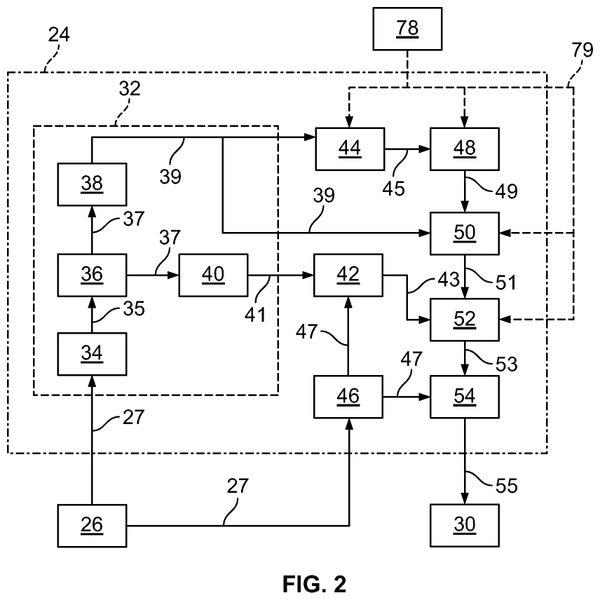

As shown in FIG. 2, the ADS 24 includes multiple distinct systems, including at least a perception system 32 for determining the presence, location, classification, and path of detected features or objects in the vicinity of the vehicle. The perception system 32 is configured to receive inputs from a variety of sensors, such as the sensors 26 illustrated in FIG. 1, and synthesize and process the sensor inputs to generate parameters used as inputs for other control algorithms of the ADS 24.

The perception system 32 includes a sensor fusion and preprocessing module 34 that processes and synthesizes sensor data 27 from the variety of sensors 26. The sensor fusion and preprocessing module 34 performs calibration of the sensor data 27, including, but not limited to, LIDAR to LIDAR calibration, camera to LIDAR calibration, LIDAR to chassis calibration, and LIDAR beam intensity calibration. The sensor fusion and preprocessing module 34 outputs preprocessed sensor output 35.

A classification and segmentation module 36 receives the preprocessed sensor output 35 and performs object classification, image classification, traffic light classification, object segmentation, ground segmentation, and object tracking processes. Object classification includes, but is not limited to, identifying and classifying objects in the surrounding environment including identification and classification of traffic signals and signs, RADAR fusion and tracking to account for the sensor's placement and field of view (FOV), and false positive rejection via LIDAR fusion to eliminate the many false positives that exist in an urban environment, such as, for example, manhole covers, bridges, overhead trees or light poles, and other obstacles with a high RADAR cross section but which do not affect the ability of the vehicle to travel along its path. Additional object classification and tracking processes performed by the classification and segmentation module 36 include, but are not limited to, freespace detection and high level tracking that fuses data from RADAR tracks, LIDAR segmentation, LIDAR classification, image classification, object shape fit models, semantic information, motion prediction, raster maps, static obstacle maps, and other sources to produce high quality object tracks. The classification and segmentation module 36 additionally performs traffic control device classification and traffic control device fusion with lane association and traffic control device behavior models. The classification and segmentation module 36 generates an object classification and segmentation output 37 that includes object identification information.

A localization and mapping module 40 uses the object classification and segmentation output 37 to calculate parameters including, but not limited to, estimates of the position and orientation of the host vehicle 12 in both typical and challenging driving scenarios. These challenging driving scenarios include, but are not limited to, dynamic environments with many cars (e.g., dense traffic), environments with large scale obstructions (e.g., roadwork or construction sites), hills, multi-lane roads, single lane roads, a variety of road markings and buildings or lack thereof (e.g., residential vs. business districts), and bridges and overpasses (both above and below a current road segment of the vehicle).

The localization and mapping module 40 also incorporates new data collected as a result of expanded map areas obtained via onboard mapping functions performed by the host vehicle 12 during operation and mapping data “pushed” to the host vehicle 12 via the wireless communication system 28. The localization and mapping module 40 updates previous map data with the new information (e.g., new lane markings, new building structures, addition or removal of constructions zones, etc.) while leaving unaffected map regions unmodified. Examples of map data that may be generated or updated include, but are not limited to, yield line categorization, lane boundary generation, lane connection, classification of minor and major roads, classification of left and right turns, and intersection lane creation. The localization and mapping module 40 generates a localization and mapping output 41 that includes the position and orientation of the host vehicle 12 with respect to detected obstacles and road features.

A vehicle odometry module 46 receives data 27 from the vehicle sensors 26 and generates a vehicle odometry output 47 which includes, for example, vehicle heading and velocity information. An absolute positioning module 42 receives the localization and mapping output 41 and the vehicle odometry information 47 and generates a vehicle location output 43 that is used in separate calculations as discussed below.

An object prediction module 38 uses the object classification and segmentation output 37 to generate parameters including, but not limited to, a location of a detected obstacle relative to the vehicle, a predicted path of the detected obstacle relative to the vehicle, and a location and orientation of traffic lanes relative to the vehicle. Data on the predicted path of objects (including pedestrians, surrounding vehicles, and other moving objects) is output as an object prediction output 39 and is used in separate calculations as discussed below.

The ADS 24 also includes an observation module 44 and an interpretation module 48. The observation module 44 generates an observation output 45 received by the interpretation module 48. The observation module 44 and the interpretation module 48 allow access by the remote access center 78. The interpretation module 48 generates an interpreted output 49 that includes additional input provided by the remote access center 78, if any.

A path planning module 50 processes and synthesizes the object prediction output 39, the interpreted output 49, and additional routing information 79 received from an online database or the remote access center 78 to determine a vehicle path to be followed to maintain the vehicle on the desired route while obeying traffic laws and avoiding any detected obstacles. The path planning module 50 employs algorithms configured to avoid any detected obstacles in the vicinity of the vehicle, maintain the vehicle in a current traffic lane, and maintain the vehicle on the desired route. The path planning module 50 outputs the vehicle path information as path planning output 51. The path planning output 51 includes a commanded vehicle path based on the vehicle route, vehicle location relative to the route, location and orientation of traffic lanes, and the presence and path of any detected obstacles.

A first control module 52 processes and synthesizes the path planning output 51 and the vehicle location output 43 to generate a first control output 53. The first control module 52 also incorporates the routing information 79 provided by the remote access center 78 in the case of a remote take-over mode of operation of the vehicle.

A vehicle control module 54 receives the first control output 53 as well as velocity and heading information 47 received from vehicle odometry 46 and generates vehicle control output 55. The vehicle control output 55 includes a set of actuator commands to achieve the commanded path from the vehicle control module 54, including, but not limited to, a steering command, a shift command, a throttle command, and a brake command.

The vehicle control output 55 is communicated to actuators 30. In an exemplary embodiment, the actuators 30 include a steering control, a shifter control, a throttle control, and a brake control. The steering control may, for example, control a steering system 16 as illustrated in FIG. 1. The shifter control may, for example, control a transmission 14 as illustrated in FIG. 1. The throttle control may, for example, control a propulsion system 13 as illustrated in FIG. 1. The brake control may, for example, control wheel brakes 17 as illustrated in FIG. 1.

In higher-level autonomous vehicles, e.g. those where the ADS 24 is a Level Three through Level Five ADS, the ADS 24 may be expected to autonomously perform lane changes in various situations. It is therefore desirable to define methods by which the ADS 24 can determine whether a lane change is appropriate and when to perform such a lane change.

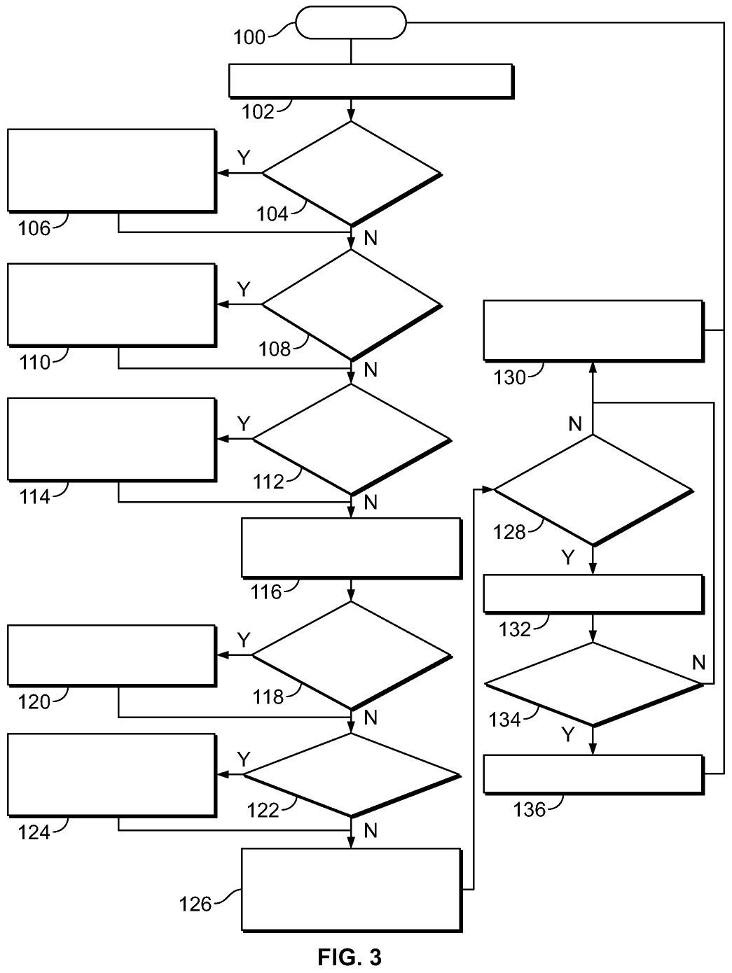

Referring now to FIG. 3, a method of controlling a vehicle according to the present disclosure is illustrated in flowchart form. While the method will be described in conjunction with the vehicle 12 illustrated in FIGS. 1 and 2 for exemplary purposes, in other embodiments the method may be implemented in vehicles having other configurations. Moreover, any names and values for variable parameters are purely exemplary. In an exemplary embodiment, the method may be performed by the controller 22 based on signals from one or more of the sensors 26. The method begins at block 100 with the ADS 24 controlling the actuators 30 of the vehicle 12, which may subsequently be referred to as a host vehicle, in an autonomous driving mode.

Lane preference values are initialized, as illustrated at block 102. In an exemplary embodiment, the lane preference values comprise a first preference value associated with a current driving lane of the vehicle 12, a second preference value associated with a return lane, a third preference associated with a driver lane request, and a fourth preference associated with a navigation route request. A return lane refers to the most recent lane occupied by the host vehicle prior to the current driving lane. A driver lane request refers to a lane identified based on a driver expression of lane preference, e.g. activation of a turn signal or other request for a lane change. A navigation route request refers to a preferred lane based on a desired vehicle route, e.g. as determined by the path planning module 50. The preference values refer to weight parameters assigned to available driving lanes. In a first embodiment, the preference values are fixed values provided by a manufacturer of the host vehicle 12. As a nonlimiting example, the first preference value may be less than the second preference value, the second preference value may be less than the third preference value, and the third preference value may be less than the fourth preference value. In such an embodiment, the first preference value CurrentLanePreference may be set to 5, the second preference value ReturnLanePreference may be set to 20, the third preference value DriverRequestLC may be set to 30, and the fourth preference value RouteRequestLC may be set to 40. In an alternate embodiment, the preference values are variable based on preferences of an occupant of the vehicle 12. Such occupant preferences may be stored in the form of, e.g. a user profile stored in non-transient data memory.

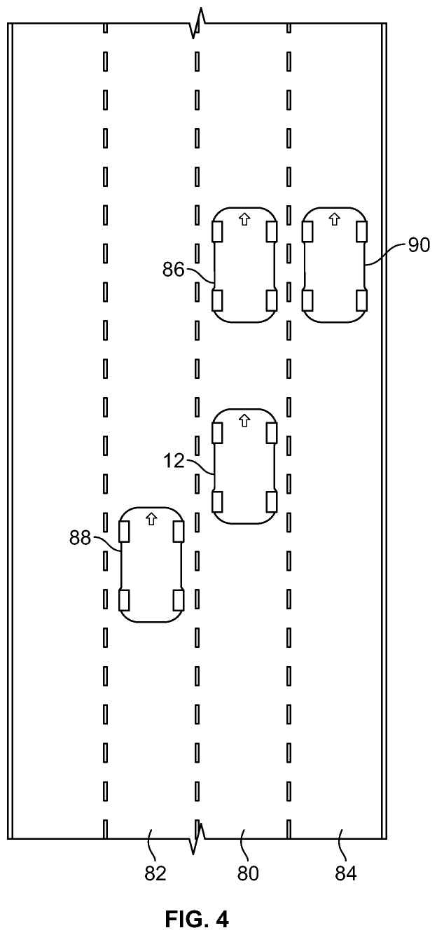

A determination is then made of whether one or more adjacent lanes are present and the location of such lanes, as illustrated in operation 104. An adjacent lane refers to a driveable lane positioned proximate the current driving lane of the host vehicle 12. With reference to FIG. 4, the host vehicle 12 is positioned in a current driving lane 80. In this exemplary configuration, a first adjacent lane 82 is positioned to a driver side of the host vehicle 12, and a second adjacent lane 84 is positioned to a passenger side of the host vehicle 12.

In response to the determination of operation 104 being positive, a preference value is calculated for the adjacent lane(s), as illustrated at block 106. In an exemplary embodiment, the preference value includes a driver-side preference value for a driver-side adjacent lane and a passenger-side preference value for a passenger-side adjacent lane. In such embodiments, the passenger-side preference value may be greater than the driver-side preference value. In such an embodiment, the passenger-side preference value LtLnExistsPreference may be set to 10, and the driver-side preference value RtLnExistsPreference may be set to 5. The algorithm may thereby bias vehicle control toward the passenger side, maintaining the driver-side adjacent lane as a passing lane.

Control thereafter proceeds to operation 108. In response to the determination of operation 104 being negative, control proceeds to operation 108 without modification of the preference values. In an alternate embodiment, in response to the determination of operation 104 being negative, the passenger-side and driver-side preference values may be set to a large negative number, e.g. −1000.

A determination is made of whether a lead vehicle is present in the current driving lane, as illustrated at operation 108. A lead vehicle refers to a vehicle proximate to and ahead of the host vehicle 12, positioned in the current driving lane. With reference to FIG. 4, a lead vehicle 86 is positioned in the current driving lane 80 ahead of the host vehicle 12.

In response to the determination of operation 108 being positive, a relative velocity VehicleDV of the lead vehicle and a lead time VehicleAheadTime are calculated, as illustrated at block 110. The relative velocity refers to a velocity difference between the host vehicle 12 and the lead vehicle, e.g. the lead vehicle 86 illustrated in FIG. 4. The lead time refers to an elapsed time between the lead vehicle passing through a location and the host vehicle 12 passing through the same location.

Control thereafter proceeds to operation 112. Likewise, in response to the determination of operation 108 being negative, control proceeds to operation 112. In an alternate embodiment, in response to the determination of operation 108 being negative, the relative velocity VehicleDV may be set to 0.

A determination is made of whether one or more adjacent lane vehicles are present and of the location of such vehicles, as illustrated in operation 112. An adjacent lane vehicle refers to a vehicle proximate the host vehicle 12, e.g. within 80 m of the host vehicle 12, and positioned in an adjacent lane. With reference to FIG. 4, a first adjacent lane vehicle 88 is positioned in the driver-side adjacent lane 82, and a second adjacent lane vehicle 90 is positioned in the passenger-side adjacent lane 84.

In response to the determination of operation 112 being positive, a relative velocity of the adjacent lane vehicle(s) is calculated, as illustrated at block 114. The relative velocity refers to a velocity difference between the host vehicle 12 and the adjacent lane vehicle(s), e.g. the first and second adjacent lane vehicles 88, 90 illustrated in FIG. 4 The relative velocity may be referred to as LeftLaneDV for a velocity difference between the host vehicle 12 and an adjacent lane vehicle to the driver side, and as RightLaneDV for a velocity difference between the host vehicle 12 and an adjacent lane vehicle to a passenger side.

Control thereafter proceeds to block 116. Likewise, in response to the determination of operation 112 being negative, control proceeds to block 116. In an alternate embodiment, in response to the determination of operation 112 being negative, the relative velocities LeftLaneDV and RightLaneDV may be set to 0.

For each adjacent lane, an adjacent lane traffic density parameter is calculated, as illustrated at block 116. In an exemplary embodiment, the adjacent lane traffic density parameter is based on the relative velocity and distance to each detected adjacent lane vehicle in the adjacent lane. In an exemplary embodiment, a driver-side traffic density parameter LeftLaneTrafficDensity may be set to a relatively large negative number, e.g. −20, in response to multiple adjacent lane vehicles being present on the driver side, to a relatively small negative number, e.g. −5, in response to a single adjacent lane vehicle being present on the driver side, and set to 0 otherwise. A passenger-side traffic density parameter RightLaneTrafficDensity may be set likewise.

A determination is made of whether an emergency vehicle is present and of the location of such vehicle, as illustrated at operation 118. An emergency vehicle refers to a vehicle which is designated and authorized, e.g. by a government agency, to respond to an emergency. Such vehicles include fire trucks, ambulances, and police vehicles. Emergency vehicles may generally be identified based on alert features such as flashing lights or sirens. Conventionally, drivers will pull aside, typically to the passenger side of the road, to allow space for an emergency vehicle to pass.

In response to the determination of operation 118 being positive, a flag is set indicating the presence and location of the emergency vehicle, as illustrated at block 120. In an exemplary embodiment, this comprises setting a flag Emergency Vehicle to 1000.

Control thereafter proceeds to operation 122. Likewise, in response to the determination of operation 118 being negative, control proceeds to operation 122. In an alternate embodiment, in response to the determination of operation 118 being negative, the flag Emergency Vehicle may be set to 0.

A determination is made of whether a rear vehicle is present, as illustrated at operation 122. A rear vehicle refers to a vehicle proximate to and behind the host vehicle 12, positioned in the current driving lane.

In response to the determination of operation 122 being positive, a relative velocity of and distance to the rear vehicle is calculated, as illustrated at block 124. The relative velocity refers to a velocity difference between the host vehicle 12 and the rear vehicle. A rear vehicle parameter RearDV may be set to the velocity difference between the host vehicle 12 and the rear vehicle, multiplied by 2.

Control then proceeds to block 126. Likewise, in response to the determination of operation 122 being negative, control proceeds to block 126.

Lane values are calculated for the current driving lane and any adjacent lanes, as illustrated at block 126. The lane value is a metric indicative of the overall desirability of travel in that lane. The lane value for the current lane may be based on factors including, but not limited to, the first preference value associated with a current driving lane, the relative velocity of any lead vehicle, the relative velocity of any rear vehicle, and the presence of any emergency vehicle flag. The lane value for a driver-side adjacent lane may be based on factors including, but not limited to, the relative velocity of any adjacent lane vehicle in the driver-side adjacent lane, the traffic density parameter of the driver-side adjacent lane, the driver-side preference value for the driver-side adjacent lane, the second preference value associated with a return lane, the third preference associated with a driver lane request, and the fourth preference associated with a navigation route request. The lane value for a passenger-side adjacent lane may be based on factors including, but not limited to, the relative velocity of any adjacent lane vehicle in the passenger-side adjacent lane, the traffic density parameter of the passenger-side adjacent lane, the passenger-side preference value for the passenger-side adjacent lane, the second preference value associated with a return lane, the third preference associated with a driver lane request, and the fourth preference associated with a navigation route request, and the presence of any emergency vehicle flag.

In an exemplary embodiment using the parameter names discussed above, the calculation of block 126 may be performed as:

CurrentLaneValue=max(1, VehicleDV−VehicleAheadTime+CurrentLanePreference−RearDV−EmergencyVehicle)

LeftLaneValue=max(0.5, LeftLaneDV+LeftLaneTrafficDensity+LtTrnSwActv*DriverRequestLC+LtNavTrnActv*RouteRequestLC+ReturnLanePreference* RtnToLtRqst+LtLnExistsPreference)

RightLaneValue=max(0, RightLaneDV+RightLaneTrafficDensity+RtTrnSwActv*DriverRequestLC+RtNavTrnActv*RouteRequestLC+ReturnLanePreference* RtnToRtRqst+RtLnExistsPreference+Emergency Vehicle)

with LtTrnSwActv and RtTrnSwActv, LtNavTrnActv and RtNavTrnActv, and RtnToLtRqst and RtnToRtRqst being variables having values of either 0 or 1 depending on the presence or absence of a driver-operable turn signal for the left or right being activated, a navigation route request for the left or right, or a lane return request for the left or right, respectively.

A determination is made of whether a lane value for an adjacent lane exceeds the lane value for the current driving lane, as illustrated at operation 128.

In response to the determination of operation 128 being negative, the current driving lane is maintained, as illustrated at block 130. The algorithm then returns to block 102. The algorithm thereby maintains the vehicle in the current driving lane unless and until the lane value for an adjacent lane exceeds the lane value for the current driving lane.

In response to the determination of operation 128 being positive, a lane change test is executed, as illustrated at block 132. The lane change test is provided to ensure that a lane change is not unnecessarily performed in response to a transient change in parameters. In an exemplary embodiment, the lane change test comprises evaluating the lane values over a plurality of cycles, e.g. for a period of one second. In such an embodiment, the lane change test may be satisfied in response to the lane value for the adjacent lane exceeding the lane value for the current driving lane through the duration of the test.

A determination is made of whether the test is satisfied, as illustrated at operation 134. In response to the determination of operation 134 being negative, control proceeds to block 130 and the current driving lane is maintained. The algorithm thereby maintains the vehicle in the current driving lane unless the lane change test is satisfied.

In response to the determination of operation 134 being positive, a lane change is commanded, as illustrated at block 136. In an exemplary embodiment, this comprises modifying a current vehicle trajectory, e.g. generated by the path planning module 50, to change lanes into the adjacent lane with the higher lane value, and subsequently executing the lane change.

As may be seen, the present disclosure provides a system and method for controlling an automotive vehicle to autonomously determine whether a lane change is desirable and to perform such a lane change if so.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further exemplary aspects of the present disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive vehicle comprising:
at least one actuator configured to control vehicle steering, shifting, acceleration, or braking;
at least one sensor configured to provide signals indicative of features external to the vehicle; and
a controller in communication with non-transient data memory, the controller being configured to selectively control the at least one actuator in an autonomous driving mode, to identify an adjacent driving lane proximate a current driving lane of the automotive vehicle based on signals from the at least one sensor, to access a current lane preference value associated with the current driving lane and an adjacent lane preference value associated with the adjacent driving lane, the current lane preference value and the adjacent lane preference value being calibrated values stored in the non-transient data memory, the controller being further configured to calculate a relative position and relative velocity of a target object external to the vehicle, to calculate, based on the current lane preference value, the adjacent lane preference value, the relative position of the target object, and the relative velocity of the target object, a current lane weight value for the current driving lane and an adjacent lane weight value for the adjacent driving lane, and to, in response to the adjacent lane weight value exceeding the current lane weight value and the controller controlling the at least one actuator in the autonomous driving mode, automatically control the at least one actuator to perform a lane change maneuver from the current driving lane to the adjacent driving lane.

2. The automotive vehicle of claim 1, further comprising a body having a driver side and a passenger side, wherein the adjacent driving lane is positioned to the passenger side of the current driving lane, and wherein the adjacent lane preference value exceeds the current lane preference value.

3. The automotive vehicle of claim 1, further comprising a body having a driver side and a passenger side, wherein the adjacent driving lane is positioned to the passenger side of the current driving lane, and wherein, in response to the target object comprising an emergency vehicle, the adjacent lane weight exceeds the current lane weight.

4. The automotive vehicle of claim 1, wherein the controller is further configured to identify a second adjacent driving lane proximate the current driving lane based on signals from the at least one sensor, to access a second adjacent lane preference value associated with the second adjacent driving lane, the second adjacent lane preference value being a calibrated value stored in the non-transient data memory, to calculate, based on the second adjacent lane preference value, a second adjacent lane weight value for the second adjacent driving lane, and to, in response to the second adjacent lane weight value exceeding the current lane weight value and the controller controlling the at least one actuator in the autonomous driving mode, automatically control the at least one actuator to perform a lane change maneuver from the current driving lane to the second adjacent driving lane.

5. The automotive vehicle of claim 1, wherein the target object is positioned in the adjacent driving lane, and wherein the controller is further configured to calculate an adjacent lane traffic density parameter based on the relative position and relative velocity of the target object, and wherein the adjacent lane weight value is based on the adjacent lane traffic density parameter.

6. The automotive vehicle of claim 5, wherein the controller is further configured to calculate a second relative position and a second relative velocity of a second target object external to the vehicle, the second object being positioned in the adjacent driving lane, and wherein the traffic density parameter is further based on the second relative position and the second relative velocity.

7. The automotive vehicle of claim 1, wherein the target object is positioned in the current driving lane, and wherein the current lane weight value is based on the relative position and relative velocity of the target object.

8. The automotive vehicle of claim 7, wherein the target object is positioned ahead of the vehicle.

9. A method of controlling a vehicle, the method comprising:
providing the vehicle with at least one actuator configured to control vehicle steering, shifting, acceleration, or braking, at least one sensor configured to provide signals indicative of features external to the vehicle, and a controller in communication with non-transient data memory, the controller being configured to selectively control the at least one actuator in an autonomous driving mode;
identifying, via the controller, an adjacent driving lane proximate a current driving lane of the vehicle based on signals from the at least one sensor;
accessing, via the controller, a current lane preference value associated with the current driving lane and an adjacent lane preference value associated with the adjacent driving lane, the current lane preference value and the adjacent lane preference value being calibrated values stored in the non-transient data memory;
calculating, via the controller, a relative position and relative velocity of a target object external to the vehicle;
calculating, via the controller, a current lane weight value for the current driving lane and an adjacent lane weight value for the adjacent driving lane based on the current lane preference value, the adjacent lane preference value, the relative position of the target object, and the relative velocity of the target object; and
in response to the adjacent lane weight value exceeding the current lane weight value and the controller controlling the at least one actuator in the autonomous driving mode, automatically controlling the at least one actuator to perform a lane change maneuver from the current driving lane to the adjacent driving lane.

10. The method of claim 9, further comprising providing the vehicle with a body having a driver side and a passenger side, wherein the adjacent driving lane is positioned to the passenger side of the current driving lane, and wherein the adjacent lane preference value exceeds the current lane preference value.

11. The method of claim 9, further comprising providing the vehicle with a body having a driver side and a passenger side, wherein the adjacent driving lane is positioned to the passenger side of the current driving lane, and wherein, in response to the target object comprising an emergency vehicle, the adjacent lane weight exceeds the current lane weight.

12. The method of claim 9, further comprising:
identifying, via the controller, a second adjacent driving lane proximate the current driving lane based on signals from the at least one sensor;
accessing, via the controller, a second adjacent lane preference value associated with the second adjacent driving lane, the second adjacent lane preference value being a calibrated value stored in the non-transient data memory;
calculating, based on the second adjacent lane preference value, a second adjacent lane weight value for the second adjacent driving lane; and
in response to the second adjacent lane weight value exceeding the current lane weight value and the controller controlling the at least one actuator in the autonomous driving mode, automatically controlling the at least one actuator to perform a lane change maneuver from the current driving lane to the second adjacent driving lane.

13. The method of claim 9, wherein the target object is positioned in the adjacent driving lane, the method further comprising calculating, via the controller, an adjacent lane traffic density parameter based on the relative position and relative velocity of the target object, wherein the adjacent lane weight value is based on the adjacent lane traffic density parameter.

14. The method of claim 13, further comprising calculating, via the controller a second relative position and a second relative velocity of a second target object external to the vehicle, the second object being positioned in the adjacent driving lane, wherein the traffic density parameter is further based on the second relative position and the second relative velocity.

15. The method of claim 9, wherein the target object is positioned in the current driving lane, and wherein the current lane weight value is based on the relative position and relative velocity of the target object.

16. The method of claim 15, wherein the target object is positioned ahead of the vehicle.
